(19) United States
(12) Patent Application Publication
(10) Pub. No.: US 2006/0113694 A1
(43) Pub. Date: Jun. 1, 2006

(54) Method and device for producing expanded polyurethane moulded bodies

(76) Inventors: Thomas Freser-Wolzenburg, Garbsen (DE); Georg-Wilheim Prahst, Lauenau (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/538,966

(22) PCT Filed: Dec. 2, 2003
(86) PCT No.: PCT/EP03/13578

§ 371 Date: Jun. 14, 2005

(30) Foreign Application Priority Data
Dec. 14, 2002 (DE) 102 58 546.6

(51) Int. Cl. B29C 44/38

(52) U.S. Cl. 264/51; 264/335; 425/4 R; 425/405.1; 425/812

(57) ABSTRACT

A method for manufacturing a foamed polyurethane molded article, that includes the steps of introducing an expandable polyurethane reactive mixture into a mold and evacuating the mold, expanding the reactive mixture expands so as to fill the mold, and exhausting gases liberated during the expanding step through one or more expansion openings disposed at one or more points of maximum height in a top mold region, each of the expansion openings being closeable by a needle valve disposed in a valve capillary. In addition the method includes sensing a temporal pressure characteristic in the valve capillary, controlling each of the one or more needle valves using the temporal pressure characteristic, so as to close the respective expansion opening in response to a pressure drop occurring when the expanding reactive mixture penetrates into the valve capillary, opening the mold, and ejecting the molded article.

### FIELD OF THE INVENTION

The present invention is directed to a method for manufacturing foamed polyurethane molded articles, whereby an expandable polyurethane reactive mixture is introduced into a mold; following the charging operation, the reactive mixture expands, filling the mold; gases liberated during the expansion process being evacuated through expansion openings located at points of maximum height in the top mold half; following the setting operation, the mold being vented and the molded article being ejected.

### BACKGROUND INFORMATION

It is known to manufacture foamed polyurethane molded articles by introducing an expandable polyurethane reactive mixture into a mold separated by a parting plane and by evacuating the mold via a vacuum channel extending peripherally around the mold in the parting plane thereof. To this end, a number of approaches have been discussed; see, for example, German Unexamined Patent Application DE-OS 15 04 278, German Patent Application DE 30 20 793 A1, European Patent Application EPO 023 749 A1 and German Patent DE 197 01 728 C2. It is necessary, in particular, to evacuate the mold in order to remove the gas present in the mold to avoid the formation of voids. This requires designing the mold halves in such a way that the parting plane lies at the highest point of the mold cavity, since, otherwise, a pocket will form out of which the gas that is present can no longer can be exhausted. This could be counteracted by evacuating the mold cavity to a very low pressure of less than 100 mbar, in particular of less than 50 mbar, before the foam rises, i.e., before the level of the foam in the mold cavity crosses the parting plane. However, such a low pressure in the mold cavity causes the foam to initially expand quickly and vigorously, until still significant amounts of blowing agent are released, with the result that an only an irregular foam structure is formed. Another drawback of evacuation via the mold parting plane is that the delivery rate via the parting plane is relatively low, particularly when the expandable reactive mixture is introduced into the open mold and evacuation is not carried out until after the mold has been closed, so that

very long cycle times are required, and thus the time required for evacuation prolongs the cycle time.

The properties of polyurethane foam are substantially determined by the density of the finished foam and the material properties of the matrix. In particular, when water is used as a chemical blowing agent, carbon dioxide being liberated by the reaction of the water with the isocyanate, it is necessary to fine-tune the formulation of the expandable polyurethane reactive mixture in order to adjust the matrix properties. Therefore, in principle, it is desirable to be able to produce foams having different bulk densities using one single formulation. To control the density of a foam while simultaneously retaining the formulation, in particular of the blowing agent concentration, a control of the pressure in the foam mold is excellently suited; see, for example, European Patent Applications EP 0 023 749 A1 and EP 0 044 226 A1, and German Patent DE 197 01 728 C2.

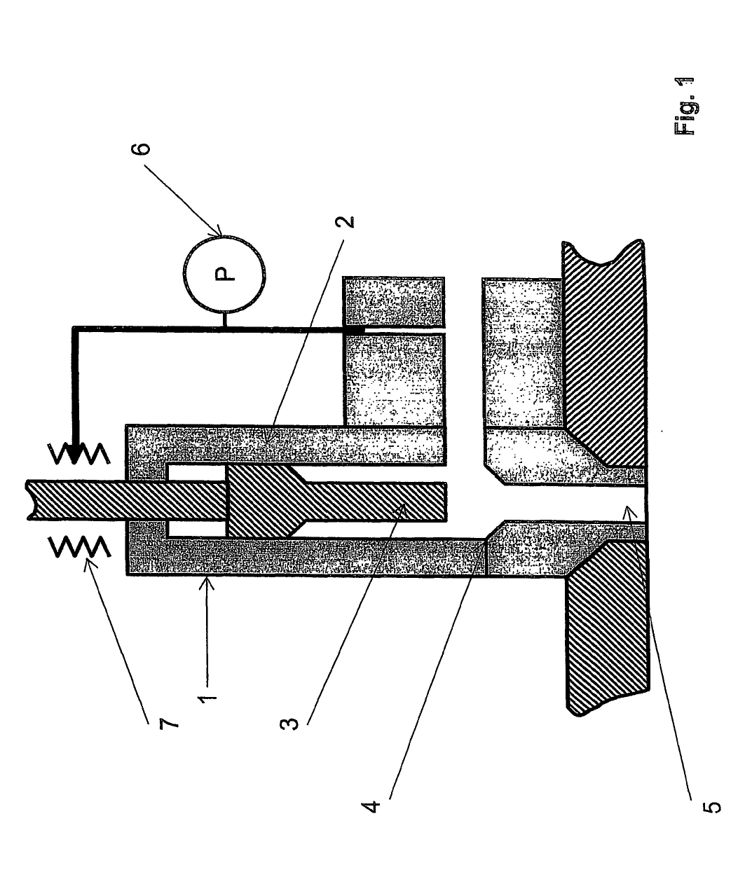

European Patent Application EP 0 023 749 A1 describes a method for the vacuum-assisted foaming of foam slab stock having slabstock sizes of typically 2×1×1 m³ (in this regard, see page 7, line 12, of EP 0 023 749 A1). To evacuate the foam slabstock mold, merely one line 19 or 20 is provided, as is apparent from FIG. 1 of EP 0 023 749 A1. In order for the mold to be evacuated within reasonable periods of time (i.e., without substantially prolonging the cycle times which correspond more or less to the curing times), lines 19 and 20 from FIG. 1 of EP 0 023 749 A1 require a substantial cross section relative to the mold size. In accordance with the EP 0 023 749 A1, the inlet side of the lines is not designed to be closeable; rather, as can likewise be inferred from FIG. 1 of the publication, stop valves 1 and 2 are only provided at the end of lines 19 and 20. If the device were operated in such a way that negative pressure prevailed at the end of the foaming process, the foam would penetrate into lines 19 and, respectively, 20 and cure there.

In accordance with German Examined Patent Application DE 23 66 184 B1, a filter (denoted by reference numeral 46 in the only figure) is provided in the suction opening of the mold. The filter must be discarded following each foaming process. In addition, the filter constitutes a relatively substantial resistance to flow, so that a rapid evacuation of the mold is not possible.

The German Patent Application DE 30 20 793 A1 also does not describe any separation between rapid evacuation and residual gas exhaustion. Rather, an evacuation gap is provided in the mold parting plane itself, that may suffice for achieving a rapid enough evacuation for relatively flat molded parts having a relatively flat volume in comparison to the peripheral size, and that is closed off by the penetrating foam mass. This results in a “flash formation” that typically must be subsequently removed by hand.

A method of the type described at the outset is known from German Patent DE 197 01 728 C2. In accordance with DE 197 01 728 C2, the top mold half has a vent opening for evacuating the mold after the polyurethane reactive mixture is introduced. If the targeted operating pressure is reached in the mold, then the suction opening is closed. In addition to the vent opening, the publication also discusses evacuating the mold via the mold parting plane; this is associated with the known disadvantage of a flash formation. To avoid the formation of voids, in particular when using molds having contoured mold cavities, the German Patent DE 197 01 728 C2 also discusses configuring so-called expansion channels in the top mold half at points of maximum height that are likewise connected to the vacuum system and through which the gases liberated during the expansion process are to be evacuated. It is provided in this context that the polyurethane foam penetrate into the channels upon reaching the top mold half, that it cure there, and thereby seal the channels. The expansion openings are provided with cleaning pushrods, which are actuated after the molded article is ejected, in order to be able to remove polyurethane still present in the channels. The drawback of the known method is that the molded article may have sprue-like projections produced by the penetration of the polyurethane into the channels that must be removed, together with the flash formations, in a costly secondary machining operation. Also to be taken into consideration when working with spatially greatly extended molded foam articles having long flow paths is that the foam front reaches the expansion channels at very different points in time. Consequently, at the channels that it reaches first, the polyurethane reactive mixture is still very flowable, since the polymerization reaction is still not yet far advanced, and can thus penetrate far into the channel. Thus, there is also the danger of the expansion opening being blocked.

### SUMMARY OF THE INVENTION

The object of the present invention is to further develop a method of the type described at the outset in such a way that, even when working with long flow paths and unfavorable conditions with respect to the mold parting plane, it will be possible to produce void-free articles within short cycle times. This objective is achieved by a method having all of the features set forth in claim 1. A device according to the present invention is described in claim 9. The dependent claims relate to advantageous embodiments of the present invention.

In accordance with the present invention, in a method for manufacturing foamed polyurethane molded articles, in which an expandable polyurethane reactive mixture is introduced into a mold; following the charging operation, the reactive mixture expands, filling the mold; gases liberated during the expansion process being evacuated through expansion openings located at points of maximum height in the top mold half; following the setting operation, the mold being vented and the molded article being ejected; the expansion openings are formed by needle valves which are controlled in such a way that they close immediately in response to the first ingress of the foam front into the valve capillary.

A device according to the present invention having a mold having a top mold region, having a suction opening for evacuation purposes and a device for venting the mold, as well as having expansion openings at one or more points of maximum height in the top mold region has the distinguishing feature that the expansion openings are formed by needle valves that are controllable in such a way that they close immediately in response to the first ingress of the foam front into the valve capillary.

It turns out that when a needle valve is used instead of the expansion opening known from the German Patent DE 197 01 728 C2, it is possible to completely prevent the formation of sprue-like projections. This merely requires controlling the valve in such a way that it closes immediately in response to the first ingress of the foam front into the valve capillary. At that moment, the polyurethane foam is clearly not yet reacted to completion and is able to be easily pushed out of the capillary by the valve needle that is descending in the capillary to close the valve, before a sprue-like projection can form. This eliminates the need for the costly secondary machining process known from the related art.

This result is all the more surprising, as a very complex geometry for the expansion openings and the cleaning pushrods is provided in the German Patent DE 197 01 728 C2, which is intended to ensure, on the one hand, that the polyurethane is not able to penetrate too far into the vacuum system and, on the other hand, that the cleaning process is to be simplified for the expansion opening. This difficulty is able to be completely circumvented by the use in accordance with the present invention of a needle valve. By closing the valve in response to the first penetration of the foam front into the capillary, any further advance of the polyurethane into the vacuum system is completely prevented. Due to the fact that polyurethane that is already present is pushed out of the valve capillary already in response to the closing of the valve, the need is not only eliminated, as already mentioned above, for the secondary machining of the molded foam article, but also for the cleaning process required in the known method in which polyurethane residues must be partially removed, even by using boring tools. Thus, another important simplification of the method is derived herefrom.

A further benefit is derived from the possibility of a process control via the valves. While the known method does not provide for or permit intervening in the expansion process, in the method according to the present invention, greatly differing variants of a process control are conceivable due to the possibility of driving the valves in any desired manner. Thus, for example, the pressure may be adjusted as a function of the formulation of the reactive mixture. Also conceivable are a control and/or regulation of the evacuation pressure during the expansion process or the setting of different evacuation capacities when a plurality of expansion valves is used for spatially extended molds.

Needle valves, as are used here, are prevalent in many fields of application of the related art. Surprisingly, it turns out that conventional needle valves may be used, without requiring any special adaptation to the use according to the present invention. To cleanly push out a polyurethane reaction mixture that is not yet reacted to completion using the valve tappet of the needle valve, it is merely necessary that the needle valve be manufactured with sufficient precision.

The manufacture of polyurethane foam is generally known and is not described in greater detail here. The method and, respectively, the device according to the present invention are not limited to special process variants, in particular formulations or process controls, but have universal applicability. Thus, the reactive mixture may be poured both into the open as well as into the closed mold, without limiting universality, it being possible for the foaming process to be initiated both by charging with carbon dioxide or another propellant, such as air, nitrogen, etc., as well as with conventional blowing agents, such as water, or a combination of blowing agents. Depending on the process variant, the mold may then be evacuated via the vacuum relief valves to a minimum negative pressure of 300 mbar. Following the foaming and setting of the reactive mixture, the mold is finally vented and opened. The molded article is ejected, if required, with the assistance of compressed air.

One preferred embodiment of the present invention provides for the liberated gases to be exhausted during the expansion process, but also for the mold to likewise be evacuated via the needle valves. Thus, the need is eliminated for an additional suction opening, as it is for evacuating via the mold parting plane. Since, in the method according to the present invention, the expansion opening is not sealed by curing a foam plug in the vacuum channel as in the known method, which necessitates a maximum possible diameter for the capillary, since otherwise the polyurethane would penetrate too far into the vacuum system before it cures, but rather simply by closing the valve, the geometric dimensions of the capillary may easily be adapted to this additional function.

Capillary diameters of between 0.2 mm and 2 mm are preferred. If the capillary diameter is selected to be smaller than 0.2 mm, the volumetric flow of reaction gases that is able to be evacuated through the capillary is greatly diminished, since the pressure loss is inversely proportional to the capillary diameter. As a result, either the cycle time is increased, or a larger number of valves is required.

On the other hand, if the capillary diameter is selected to be larger than 2 mm, then, due to the minimal pressure loss, it becomes more difficult to detect the change in the flow through the capillary as the foam penetrates that is used to determine the valve closing. Compensating by lengthening the capillary (in accordance with Hagen-Poiseuille, the pressure loss is proportional l/d (=length to diameter of the capillary) considerably influences the size, which is to be kept small in accordance with the installation possibilities on and/or in the mold.

In another preferred embodiment of the present invention, to control the needle valve(s), a chemical and/or physical quantity that changes rapidly in response to the ingress of the foam front into the valve capillary is recorded, and the needle valve is controlled as a function of the time characteristic of this quantity. The advantage of this type of control is that the valve closes immediately and autonomously in response to penetration of the foam front into the capillary.

As a control variable, preferably the temporal pressure characteristic in the valve capillary is sensed, the control being designed in such a way that the valve closes immediately in response to the pressure drop in the capillary occurring when the foam front penetrates into the valve capillary. In accordance with the Hagen-Poiseuille principle, the pressure loss in the capillary is dependent on the viscosity of the medium flowing through. In response to penetration of the foam front, the pressure loss increases by approximately a factor of 10⁵-10⁶ because of the difference between the viscosity of polyurethane and that of air. For that reason, in accordance with the present invention, a pressure sensor is provided for recording pressure whose output signal is fed to a control unit which, in turn, converts it into a control signal for moving the valve needle. As pressure sensors, the generally known piezoelectric pressure sensors are suited, for example.

Another variable for controlling the valve in the sense described above may also be the flow rate through the valve capillary, for example, which, for the same reasons as described above, decreases by a comparable factor in response to penetration of the foam front into the capillary. However, the method according to the present invention is not limited to these especially suited control variables which are mentioned exemplarily.

Other preferred embodiments of the present invention provide for the needle valves to be used to assist in the removal process, in addition to venting the mold and/or acting upon the mold with compressed air. This also reduces the number of component parts, so that cost advantages are attained.

A system for manufacturing polyurethane molded articles is further simplified by supplying a plurality of needle valves with negative pressure and/or with compressed air from a shared media supply. A negative pressure is nevertheless able to be individually adjusted at each needle valve due to the autonomous control provided for each valve via a proportional valve.

The present invention is explained in greater detail in the following with reference to the figures, which show:

FIG. 1: in a schematic longitudinal sectional representation, a needle valve that is controllable in accordance with the present invention via a pressure sensor;

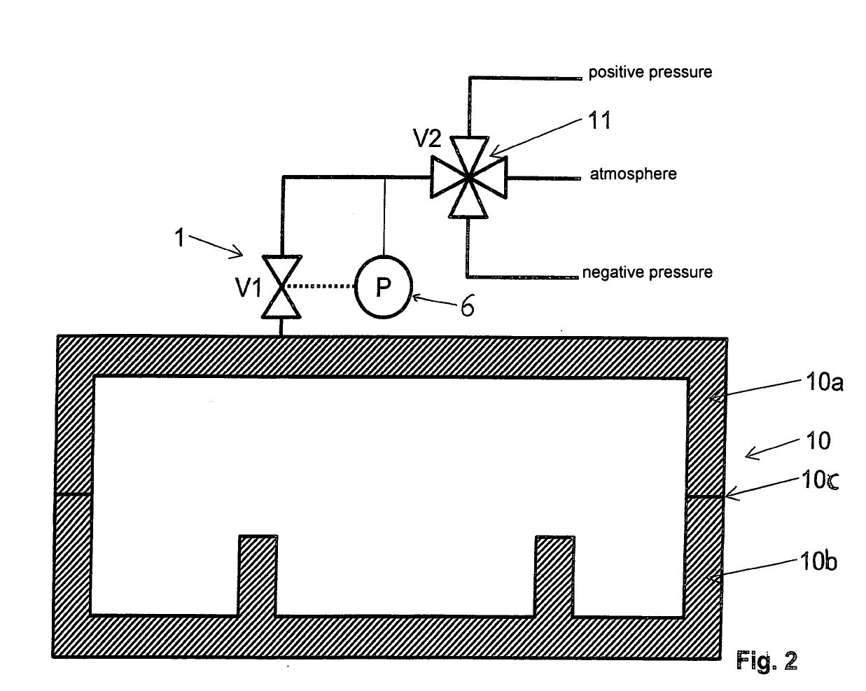

FIG. 2: in a schematic longitudinal sectional representation, a device in accordance with the present invention having a needle valve;

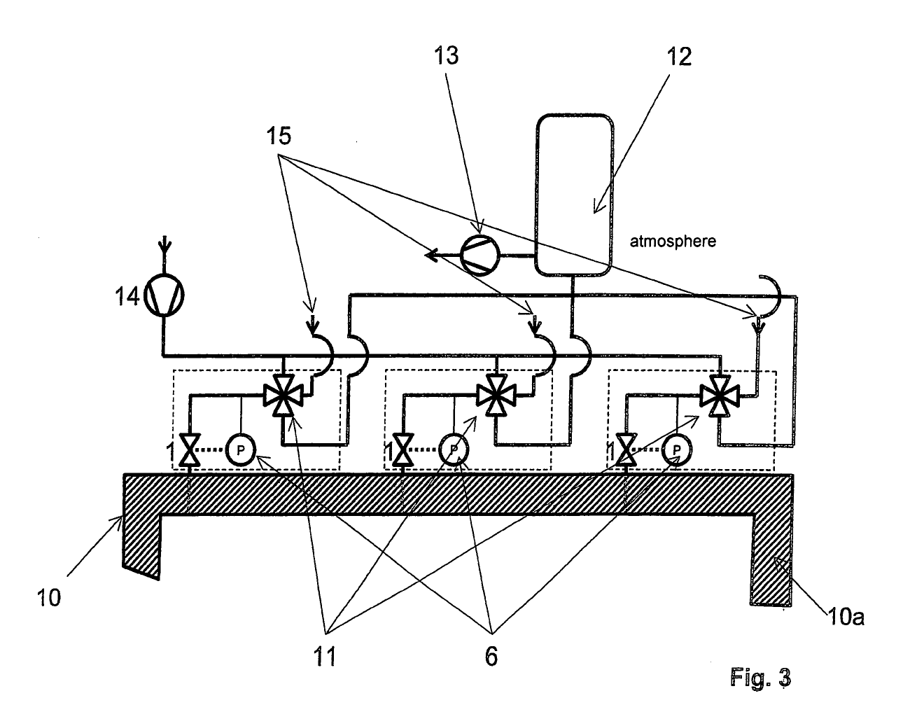

FIG. 3: in a schematic longitudinal sectional representation, a device in accordance with the present invention having a plurality of needle valves and a shared negative pressure and/or positive pressure supply;

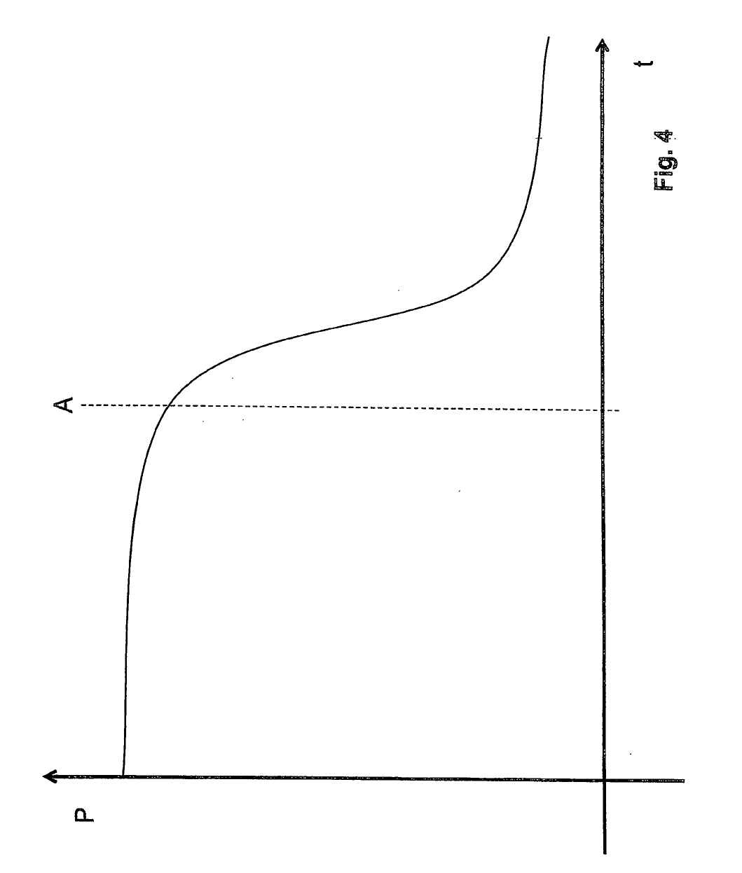

FIG. 4: schematically, the characteristic curve of the pressure in the valve capillary during the foaming process and upon penetration of the foam front into the valve.

FIG. 1 illustrates a needle valve 1 suited for implementing the method according to the present invention. Needle valve 1 essentially includes a housing 2, a valve needle 3, a valve seat 4, as well as a capillary 5. Also shown is a pressure sensor 6. As soon as the foam front penetrates into valve capillary 5, the pressure in capillary 5 drops sharply. This pressure drop is detected by pressure sensor 6 and converted via a control unit (not shown in the figure) into a control signal for valve actuation 7. In response to this control signal, valve needle 3 descends and valve 1 closes. In the process, the polyurethane that has already penetrated into capillary 5 is pushed out through valve needle 3.

FIG. 2 shows one preferred embodiment of a device in accordance with the present invention. A mold 10 is shown having a top 10a and a bottom mold half 10b. The two mold halves are separated from one another by mold parting plane 10c. Mold parting plane 10c preferably has a vacuum seal. Also illustrated is a needle valve 1 situated in top mold half 10a. Needle valve 1 communicates via a four-way valve 11 both with a negative pressure and a positive pressure source (not shown here), as well as with the atmosphere. This system not only permits the gases liberated during the expansion process to be exhausted via needle valve 1, but also mold 10 to be evacuated or vented, as well as acted upon by positive pressure. The output signal from pressure sensor 6 is used for controlling the valve actuation of needle valve 1. In response to a pressure drop caused by polyurethane penetrating into valve 1, valve needle 3 is lowered and valve 1 is closed, the already penetrated polyurethane being pushed out.

FIG. 3 depicts the connection of a plurality of valves 1 to a shared media supply. The arrangement of a plurality of valves may be useful when working with very extended, flat-shaped molds, in order to compensate for the pressure loss caused by long flow paths, by individually adjusting the negative pressure at valves 1. Another possible application is for molds having a complex geometric shape, in particular having a plurality of points of maximum height, in order to prevent the formation of voids. Other possible applications are conceivable. Discernible in the figure are a plurality of needle valves 1 having pressure sensors 6, which are situated in top mold half 10a of mold 10. Needle valves 1 are each connected via a four-way valve 11 to shared supply lines leading to a negative and/or positive pressure source 14. In this case, the negative pressure source is constituted of a vacuum vessel 12 which is evacuable by a vacuum pump 13. Moreover, each four-way valve 11 also has an outlet to atmosphere. Four-way valve 11 is preferably a proportional valve, to render possible an individual adjustment of the negative pressure at each valve 1, in spite of a shared media supply.

FIG. 4 shows the pressure characteristic including the control-triggering pressure drop occurring when the foam front reaches the valve capillary. As is discernible, the pressure drops suddenly in response to penetration of the foam front (instant A). The slight drop in pressure that is already observable beforehand, is attributed to the increase in viscosity of the reaction mixture during the advancing polymerization reaction. The steep pressure drop in response to penetration of the foam front is sensed by the pressure sensor and used as a triggering factor for closing the valve.

1-16. (canceled)

17. A method for manufacturing a foamed polyurethane molded article, the method comprising:
introducing an expandable polyurethane reactive mixture into a mold and evacuating the mold, the mold having a top mold region;
expanding the reactive mixture expands so as to fill the mold;
exhausting gases liberated during the expanding step through one or more expansion openings disposed at one or more points of maximum height in the top mold half, each of the expansion openings being closeable by a needle valve disposed in a valve capillary;
sensing a temporal pressure characteristic in the valve capillary;
controlling each of the one or more needle valves using the temporal pressure characteristic, so as to close the respective expansion opening in response to a pressure drop occurring when the expanding reactive mixture penetrates into the valve capillary;
opening the mold; and
ejecting the molded article.

18. The method as recited in claim 17, wherein the evacuating of the mold is performed using the one or more the needle valves.

19. The method as recited in claim 17, wherein the introducing step is also performed using the needle valves.

20. The method as recited in claim 17, wherein the ejecting of the molded article is performed using the needle valves to act upon the mold with compressed air.

21. The method as recited in claim 17, wherein each of the one or more needle valves is supplied with at least one of negative pressure and compressed air from a shared media supply.

22. The method as recited in claim 17, wherein the one or more needle valves includes a plurality of needle valves and further comprising adjusting a negative pressure to each of the needle valves individually.

23. A device comprising:
a mold having a top mold region and configured to receive an expandable polyurethane reactive mixture;
a suction opening configured to evacuate the mold;
a vent configured to vent the mold;
one or more expansion openings disposed at one or more points of maximum height in the top mold region, each of the expansion openings being formed by a needle valve disposed in valve capillaries, wherein the needle valves are closable in response to a pressure drop occurring when the expandable polyurethane reactive mixture penetrates into the valve capillary.

24. The device as recited in claim 23, wherein the suction opening is likewise formed by a respective one of the needle valves.

25. The device as recited in claim 23, wherein the needle valve enable the mold to be acted upon with compressed air.

26. The device as recited in claim 23, further comprising a four-way valve, and wherein the at least one needle valve is connected in series to the four-way valve, the four-way valve capable of establishing a communication to at least one of a negative pressure source, a positive pressure source and atmospheric pressure.

27. The device as recited in claim 26, wherein the four-way valve is a proportional valve.

28. The device as recited in claim 23, further comprising a media supply, and wherein the at least one needle valve includes a plurality of needle valves, each supplied with at least one of negative pressure and compressed air from the media supply.
